(19) United States
(12) Patent Application Publication
(10) Pub. No.: US 2026/0265849 A1
(43) Pub. Date: Sep. 10, 2026

(54) DIRECT REDUCTION SYSTEM AND METHOD UTILIZING PRE-REDUCING FURNACE AND HEAT EXCHANGER

(71) Applicant: Midrex Technologies, Inc., Charlotte, NC (US)

(72) Inventors: Katsuma Fujiwara, Pineville, NC (US); Stephen Brooks, Pineville, NC (US)

(21) Appl. No.: 19/555,197

(22) Filed: Mar. 3, 2026

Related U.S. Application Data
(60) Provisional application No. 63/767,781, filed on Mar. 6, 2025.

(51) Int. Cl. C21B 13/14; C21B 13/00

(52) U.S. Cl. CPC C21B 13/146; C21B 13/0073; C21B 2100/22; C21B 2100/44; C21B 2100/66

(57) ABSTRACT

A system for the direct reduction of iron includes a pre-reducing furnace, a main reducing furnace, and a reducing gas heat exchanger. The pre-reducing furnace includes an iron oxide intake for receiving an iron oxide, a reducing gas port for injecting a main top gas from a main reduction furnace for partial reduction of the iron oxide, and a reduced iron discharge for discharging a partially reduced iron product. The main reducing furnace includes a main iron oxide intake for receiving the partially reduced iron product and a main top gas offtake for removing the main top gas resulting from reduction of the partially reduced iron product. The reducing gas heat exchanger is fluidly coupled between the reducing gas port of the pre-reducing furnace and the main top gas offtake of the main reducing furnace for cooling the main top gas prior to injection into the pre-reducing furnace.

### CROSS-REFERENCE TO RELATED APPLICATION

The present disclosure claims the benefit of priority of co-pending U.S. Provisional Patent Application No. 63/767,781, filed on Mar. 6, 2025, and entitled “DIRECT REDUCTION SYSTEM AND METHOD UTILIZING PRE-REDUCING FURNACE AND HEAT EXCHANGER,” the contents of which are incorporated in full by reference herein.

### TECHNICAL FIELD

The present disclosure relates generally to direct reduced iron (DRI) production and steelmaking fields. More specifically, the present disclosure relates to a direct reduction (DR) system and method utilizing a pre-reducing furnace and heat exchanger.

### BACKGROUND

According to a series of laboratory tests and observations of DR plant operations, the higher the initial reduction temperature is and/or the higher the initial reduction speed is, the more the iron oxide swells at the initial reduction stage or the reduction degree up to 0~30%. The swelling by the lattice structure changes from Fe2O3 to Fe3O4 or FeO at the upper section in the shaft furnace (SF) reduces the physical strength of the iron oxide, which enhances later disintegration through the movements in the moving bed. The reduced physical strength somewhat recovers later as the formation of the metallic iron progresses to sinter and shrink the material, but the strength recovery cannot make up the earlier strength reduction if the swelling exceeds the recovery. Also, more rapid and more significant swelling sometimes enhances the clustering of the material in the SF since the swelling helps the material to deform in a flat shape and increases the contact area under the burden load in SF. The larger contact area for the deformed iron oxide facilitates the material to stick together and make clusters. Also, the fines generated from the disintegration can also help to make clusters since the fines can bridge the iron oxide.

In some applications, it is desirable to use cold agglomerate (CA) as the feedstock of a suitable direct reduced iron (DRI) process. However, CA used as or within such feedstocks can be particularly susceptible to the possibility of clustering issues, which may stop plant operation and seriously affect productivity. A CA is a binder-bonded iron ore feed produced from fines or concentrates at ambient or low temperature, without high-temperature firing or induration, and sized for use in direct reduction processes. Its strength comes from chemical and/or physical bonding rather than sintering. Such feedstock material may be bonded with conventional binders since it cannot maintain the physical strength at the initial reduction temperature, typically 400~700°C. in the SF. Furthermore, such feedstock material tends to disintegrate or make clusters since the bonding strength by the binder is lost when it swells before the sintering of metallic iron starts in the temperature range. Therefore, the swelling can be restrained if the temperature is maintained low enough for the binder to keep the bonding strength until the metallic iron formation starts. This enables the prevention of the disintegration or clustering in the SF.

Currently, there are no multi-stage DR SFs for the purpose of temperature control in the early reduction stage. Multi-stage DR SFs have been proposed that enable the production of DRI from fine ore particles. However, there are no heat exchangers between such multi-stage furnaces to adjust reducing gas temperature since the necessity of lower reducing gas temperature is unique to using CA as the feedstock of the DR SF. Generally, higher temperature is better for reduction in terms of its kinetics. For an example of heat recovery from exhaust gas, a single-stage reduction furnace with top gas waste heat recovery has been proposed. However, this is for saving energy, but not for realizing the ideal heat pattern for the reduction of CA. Generally speaking, DR with fine ore cannot guarantee as high productivity as DR with agglomerates, like oxide pellets or CA. The relatively low permeability of fine ore limits the reducing gas flow rate and thus the plant productivity.

CA is appealing because it avoids high-temperature pellet induration, reducing energy use, CAPEX, and CO2 emissions, and CA allows greater use of ore fines and residues. However, because CA strength comes from binders rather than sintering, its mechanical strength decreases at elevated temperature as binders decompose. This can lead to cracking, fines generation, increased risk of clustering or sticking in the shaft furnace, and loss of bed permeability, which is why cold agglomerates are typically used only in limited blends with indurated pellets.

As such, a need exists in the art for a DRI system and associated process that overcome the above limitations.

This background is provided as an illustrative contextual environment only. It will be readily apparent to those of ordinary skill in the art that the systems and methods of the present disclosure may be implemented in other contextual environments as well.

### SUMMARY

Therefore, it is an object of the present disclosure to provide a DRI system and associated process that overcome the limitations of the known art. Embodiments of the present disclosure improve upon prior systems and methods to produce DRI by including one or more of a pre-reducing furnace, a main reducing furnace, and a reducing gas heat exchanger in order to mitigate the disintegration and clustering of the iron oxide during the reduction reaction.

To avoid clustering issues due to the use of CA as feedstock, the Fe3O4 reduction to FeO should be completed at a temperature lower than 700° C. This is based on experimental results. In a conventional plant, the Fe3O4 reduction occurs between 700° C. and 760° C. Thus, one needs to decrease the process temperature where Fe3O4 is reduced to FeO. There are two possible operational efforts to realize this heat pattern, lowering the reducing gas flow rate or lowering the temperature of the reducing gas before injection into the reducing furnace. However, both can lower the product quality due to the shortage of heat and/or reductants.

Embodiments of the pre-reducing furnace and reducing gas heat exchanger of the present disclosure enable control of the process conditions for the Fe3O4 reduction separately from any other process conditions. Thus, the poor product quality resulting from lowering the reducing gas flow rate or lowering the temperature of the reducing gas before injection into the reducing furnace does not occur.

Embodiments of the present disclosure utilize the pre-reducing furnace and the reducing gas heat exchanger located between and/or fluidly coupled between the pre-reducing furnace and the main reducing furnace in order to independently control the reducing gas temperature and the initial temperature of reduction. In several embodiments, a DRI system including the disclosed pre-reducing furnace, the main reducing furnace, and the reducing gas heat exchanger between them enables cooling of exhausted gas from the main reducing furnace in order to realize the ideal heat pattern in the pre-reducing furnace without any changes in the reduction conditions in the main reducing furnace. In some embodiments, only a portion of the main top gas may be cooled utilizing the reducing gas heat exchanger, and another portion of the main top gas may bypass the reducing gas heat exchanger utilizing a main top gas bypass fluidly coupled between the pre-reducing furnace and main reducing furnace. By selectively allowing the flow of the portion of the main top gas through the main top gas bypass and/or altering an amount of the portion flown through the main top gas bypass, the degree of cooling of the main top gas may be independently controlled.

Top gas fuel may be the cooling fluid flown through the reducing gas heat exchanger. In which case, the reducing gas heat exchanger may also function to preheat the top gas fuel, which results in reducing an amount of or even eliminating the need for additional NG consumption as the burner fuel of the reformer. In some embodiments, only a portion of the top gas fuel may flow through the reducing gas heat exchanger, and another portion of the top gas fuel may bypass the reducing gas heat exchanger utilizing a top gas fuel bypass having an inlet fluidly coupled between top gas scrubber and the reducing gas heat exchanger. By selectively allowing the flow of the portion of the top gas fuel through the top gas fuel bypass and/or altering an amount of the portion flown through the top gas fuel bypass, the degree of cooling of the main top gas and/or heating of the top gas fuel may be independently controlled. Alternatively, other process gas in a suitable DRI system may be utilized as the cooling fluid flown through the reducing gas heat exchanger, e.g., as used in a hydrogen DRI system/process.

To achieve the foregoing and other objects and advantages, in one aspect, the present subject matter is directed to a system for the direct reduction of iron including a pre-reducing furnace, a main reducing furnace, and a reducing gas heat exchanger. The pre-reducing furnace includes an iron oxide intake located at a top of the pre-reducing furnace and configured to receive an iron oxide. The pre-reducing furnace further includes a reducing gas port configured to inject a main top gas from a main reduction furnace into the pre-reducing furnace for partial reduction of the iron oxide received via the iron oxide intake. The pre-reducing furnace also includes a reduced iron discharge at a bottom of the pre-reducing furnace and configured to discharge a partially reduced iron product. The main reducing furnace includes a main iron oxide intake located at top of the main reducing furnace and configured to receive the partially reduced iron product. The main reducing furnace also includes a main top gas offtake located above a bustle port and configured to remove the main top gas resulting from reduction of the partially reduced iron product within the main reducing furnace. The reducing gas heat exchanger is fluidly coupled between the reducing gas port of the pre-reducing furnace and the main top gas offtake of the main reducing furnace and is configured to cool the main top gas prior to injection into the pre-reducing furnace.

In at least one embodiment, the pre-reducing furnace may be configured to partially reduce the iron oxide at a temperature less than 700° C. Additionally or alternatively, the main reducing furnace may be configured to reduce the partially reduced iron at a temperature greater than or equal to 700° C. In some such embodiments or different embodiments, cooling the main top gas prior to injection into the pre-reducing furnace may include cooling a portion of the main top gas. Additionally or alternatively, the system may further include a main top gas bypass fluidly coupled between the reducing gas port of the pre-reducing furnace and the main top gas offtake of the main reducing furnace and bypassing the reducing gas heat exchanger to provide another portion of the main top gas for injection into the pre-reducing furnace.

In additional or alternative embodiments, the pre-reducing furnace may further include a top gas offtake located above the reducing gas port and configured to remove top gas resulting from partial reduction of iron oxide within the pre-reducing furnace. In some such embodiments or different embodiments the system may further include a top gas scrubber fluidly coupled with the top gas offtake and configured to process the top gas to form a process gas. Furthermore or alternatively, the top gas scrubber may include a top gas fuel offtake configured for providing a portion of the processed top gas as a top gas fuel. Additionally or alternatively, the reducing gas heat exchanger may be fluidly coupled to the top gas fuel offtake of the top gas scrubber and configured to transfer heat from the main top gas to the top gas fuel. In some such embodiments or different embodiments, transferring heat from the main top gas to the top gas fuel may include transferring heat from the main top gas to a portion of the top gas fuel. Additionally or alternatively, the system may further include a top gas fuel bypass having an inlet fluidly coupled between the top gas fuel offtake of the top gas scrubber and the reducing gas heat exchanger and bypassing the reducing gas heat exchanger.

In an additional or alternative embodiment, the main reducing furnace may further include the bustle port configured to inject a reduction gas into the main reducing furnace. In some such embodiments or alternative embodiments, the reduction gas may be formed from the process gas. Additionally or alternatively, the system may further include a reformer fluidly coupled between a preheater and the bustle port of the main reducing furnace. In some such embodiments or different embodiments, the reduction gas may include the process gas reformed within the reformer. In additional or alternative embodiments, the reformer may be configured to utilize the top gas fuel, subsequent to heat transfer with the main top gas in the reducing gas heat exchanger, supplemented with a natural gas as burner fuel for the reformer. Furthermore or alternatively, the system may include a conduit coupled between the reduced iron discharge of the pre-reducing furnace and the main iron oxide intake of the main reducing furnace and configured to provide the partially reduced iron product from the pre-reducing furnace to the main reducing furnace. In some such embodiments, the conduit may include a seal gas intake configured to divert the main top gas into the main top gas offtake of the main reducing furnace.

In an additional or alternative aspect, the present subject matter is directed to a method for the direct reduction of iron including charging an iron oxide at a top of a pre-reducing furnace. The method also includes injecting a main top gas from a main reducing furnace within the pre-reducing furnace utilizing a reducing gas port of the pre-reducing furnace. The method further includes partially reducing the iron oxide within the pre-reducing furnace utilizing the main top gas to form a partially reduced iron product. The method additionally includes discharging the partially reduced iron product from the pre-reducing furnace. In a further element, the method includes charging the partially reduced iron product at a top of the main reducing furnace. The method also includes injecting a reduction gas into the main reducing furnace utilizing a bustle gas port. Another element of the method includes further reducing the partially reduced iron product within the main reducing furnace utilizing the reduction gas to form a reduced iron product. The method additionally includes removing the main top gas, resulting from further reducing the partially reduced iron product, utilizing a main top gas offtake of the main reducing furnace located above a bustle port of the main reducing furnace. Furthermore, the method includes cooling the main top gas removed from the top gas offtake utilizing a reducing gas heat exchanger prior to injecting the main top gas within the pre-reducing furnace.

In at least one embodiment, the iron oxide may include 80% or more Fe3O4, Fe2O3, or a combination thereof. Additionally or alternatively, the partially reduced iron product may include 80% or more FeO. In some such embodiments or different embodiments, the reduced iron product may include 80% or more elemental iron, metallic iron, cementite, or a combination thereof. In additional or alternative embodiments, partially reducing the iron oxide within the pre-reducing furnace may include partially reducing the iron oxide at a temperature less than 700° C. In some such embodiments or different embodiments, further reducing the partially reduced iron product within the main reducing furnace may include further reducing the partially reduced iron at a temperature greater than or equal to 700° C.

In an additional or alternative embodiment, cooling the main top gas prior to injection into the pre-reducing furnace may include cooling a portion of the main top gas utilizing the reducing gas heat exchanger prior to injecting the main top gas within the pre-reducing furnace. Furthermore or alternatively, the method may include bypassing, for another portion of the main top gas, the reducing gas heat exchanger utilizing a main top gas bypass fluidly coupled between the reducing gas port of the pre-reducing furnace and the main top gas offtake of the main reducing furnace to provide the another portion of the main top gas for injection into the pre-reducing furnace.

In some such embodiments or different embodiments, the method may further include removing a top gas, resulting from partially reducing the iron oxide within the pre-reducing furnace, utilizing a top gas offtake of the pre-reducing furnace located above the reducing gas port. In some such embodiments or alternative embodiments, the method may include processing the top gas utilizing a top gas scrubber fluidly coupled with the top gas offtake to form a process gas. Additionally or alternatively, the method may include discharging a top gas fuel from a top gas fuel offtake of the top gas scrubber. In some such embodiments or different embodiments, the top gas fuel may include a portion of the top gas processed utilizing the top gas scrubber. Additionally or alternatively, the method may include flowing the top gas fuel through the reducing gas heat exchanger to transfer heat from the main top gas to the top gas fuel. In some such embodiments, flowing the top gas fuel through the reducing gas heat exchanger to transfer heat from the main top gas to the top gas fuel may include flowing a portion of the top gas fuel through the reducing gas heat exchanger to transfer heat from the main top gas to the portion of the top gas fuel. Furthermore or alternatively, the method may include flowing another portion of the top gas fuel through a top gas fuel bypass having an inlet fluidly coupled between the top gas fuel offtake of the top gas scrubber and the reducing gas heat exchanger in order to bypass the reducing gas heat exchanger.

Additionally or alternatively, the method may include forming the reduction gas injected into the bustle gas port of the main reducing furnace from the process gas. In some such embodiments or different embodiments, the method may also include reforming the process gas utilizing a reformer fluidly coupled between a preheater and the bustle port of the main reducing furnace. Furthermore or alternatively, the reduction gas may include the process gas reformed within the reformer. Additionally or alternatively, the method may further include flowing the partially reduced iron product discharged from the pre-reducing furnace through a conduit prior to charging the partially reduced iron product at the top of the main reducing furnace. In some such embodiments, the method may include injecting a seal gas into the conduit to divert the main top gas into the main top gas offtake of the main reducing furnace.

Embodiments of the invention can include one or more or any combination of the above features and configurations.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the accompanying drawings, in which:

FIG. 1 is a process diagram illustrating one exemplary embodiment of a DRI system and associated process utilizing a pre-reducing furnace, a main reducing furnace, and a reducing gas heat exchanger, in accordance with aspects of the present subject matter;

FIG. 2A illustrates exemplary embodiments of method elements, one or more of which may be implemented in a method for the direct reduction of iron utilizing one or more of a pre-reducing furnace, a main reducing furnace, and a reducing gas heat exchanger, in accordance with aspects of the present subject matter;

FIG. 2B illustrates exemplary embodiments of method elements, one or more of which may be implemented in a method for the direct reduction of iron utilizing one or more of a pre-reducing furnace, a main reducing furnace, and a reducing gas heat exchanger, in accordance with aspects of the present subject matter;

FIG. 2C illustrates exemplary embodiments of method elements, one or more of which may be implemented in a method for the direct reduction of iron utilizing one or more of a pre-reducing furnace, a main reducing furnace, and a reducing gas heat exchanger, in accordance with aspects of the present subject matter;

FIG. 2D illustrates exemplary embodiments of method elements, one or more of which may be implemented in a method for the direct reduction of iron utilizing one or more of a pre-reducing furnace, a main reducing furnace, and a reducing gas heat exchanger, in accordance with aspects of the present subject matter; and

FIG. 2E illustrates exemplary embodiments of method elements, one or more of which may be implemented in a method for the direct reduction of iron utilizing one or more of a pre-reducing furnace, a main reducing furnace, and a reducing gas heat exchanger, in accordance with aspects of the present subject matter.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

The terms “upstream” and “downstream” refer to the relative direction with respect to fluid flow in a fluid pathway, including the flow of solid material that behaves the same or similar to a fluid, e.g., a flow of small or fine particles. For example, “upstream” refers to the direction from which the fluid flows, and “downstream” refers to the direction to which the fluid flows.

As used herein, the terms “first,” “second,” “third,” and the like may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Again, to avoid clustering issues due to the use of CA as feedstock, the Fe3O4 reduction to FeO should be completed at a temperature lower than 700° C. This is based on experimental results. In a conventional plant, the Fe3O4 reduction occurs between 700° C. and 760° C. Thus, one needs to decrease the process temperature where Fe3O4 is reduced to FeO. There are two possible operational efforts to realize this heat pattern, lowering the reducing gas flow rate or lowering the temperature of the reducing gas before injection into the reducing furnace. However, both can lower the product quality due to the shortage of heat and/or reductants.

Embodiments of the pre-reducing furnace and reducing gas heat exchanger of the present disclosure enable control of the process conditions for the Fe3O4 reduction separately from any other process conditions. Thus, the poor product quality resulting from lowering the reducing gas flow rate or lowering the temperature of the reducing gas before injection into the reducing furnace does not occur.

Embodiments of the present disclosure utilize the pre-reducing furnace and the reducing gas heat exchanger located between and/or fluidly coupled between the pre-reducing furnace and the main reducing furnace in order to independently control the reducing gas temperature and the initial temperature of reduction. In several embodiments, a DRI system including the disclosed pre-reducing furnace, the main reducing furnace, and the reducing gas heat exchanger between them enables cooling of exhausted gas from the main reducing furnace in order to realize the ideal heat pattern in the pre-reducing furnace without any changes in the reduction conditions in the main reducing furnace. In some embodiments, only a portion of the main top gas may be cooled utilizing the reducing gas heat exchanger, and another portion of the main top gas may bypass the reducing gas heat exchanger utilizing a main top gas bypass fluidly coupled between the pre-reducing furnace and main reducing furnace. By selectively allowing the flow of the portion of the main top gas through the main top gas bypass and/or altering an amount of the portion flown through the main top gas bypass, the degree of cooling of the main top gas may be independently controlled.

Top gas fuel may be the cooling fluid flown through the reducing gas heat exchanger. In which case, the reducing gas heat exchanger may also function to preheat the top gas fuel, which results in reducing an amount of or even eliminating the need for additional NG consumption as the burner fuel of the reformer. In some embodiments, only a portion of the top gas fuel may flow through the reducing gas heat exchanger, and another portion of the top gas fuel may bypass the reducing gas heat exchanger utilizing a top gas fuel bypass having an inlet fluidly coupled between top gas scrubber and the reducing gas heat exchanger. By selectively allowing the flow of the portion of the top gas fuel through the top gas fuel bypass and/or altering an amount of the portion flown through the top gas fuel bypass, the degree of cooling of the main top gas and/or heating of the top gas fuel may be independently controlled. Alternatively, other process gas in a suitable DRI system may be utilized as the cooling fluid flown through the reducing gas heat exchanger, e.g., as used in a hydrogen DRI system/process.

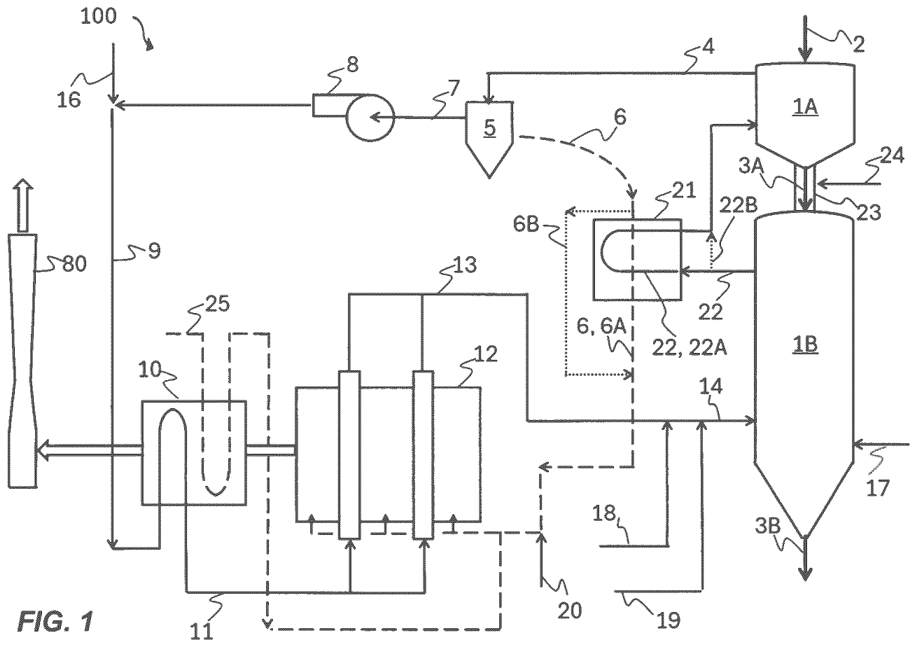

Referring now generally to the drawings, FIG. 1 illustrates an exemplary embodiment of a DRI system including a pre-reducing furnace, a main reducing furnace, and a reducing gas heat exchanger and associated process for the direct reduction of iron overcoming the limitations of the known art. It will be appreciated that the exemplary direct reduced iron processes and systems depicted and described herein are by way of example only, and, in other exemplary embodiments, the DRI process, system, shaft furnace, plant, or the like may have any other suitable configuration.

One or more of the method elements disclosed herein may be utilized in a suitable process for the direct reduction of iron and incorporated in any suitably configured direct reduction process, system, shaft furnace, or the like. It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently.

While FIG. 1 and some embodiments of the DRI system and method are illustrated and described herein with respect to a process utilizing natural gas (NG) as added process gas and utilizing a NG reformer, it should be appreciated that the present subject matter may be equally applicable to DRI systems and methods utilizing hydrogen or a mix of hydrogen and NG and suitable components, e.g., a reformer, gas heating devise, or electrical gas heating device suitable for use with hydrogen or a mix of hydrogen and NG. Furthermore, the aspects of the present subject matter are equally applicable to other process gas stream compositions, e.g., containing NH3 or where NH3 is included in or makes up the majority and up to all of the makeup gas. Furthermore, the present subject matter is applicable to DRI systems that do not include a reformer, e.g., a system utilizing hydrogen as the process gas and/or only hydrogen makeup gas, which may utilize electrical process gas heating. In some exemplary embodiments, top gas fuel may not flow through the reducing gas heat exchanger. Rather, process gas of the system may be flown through the reducing gas heat exchanger for heat exchange purposes, such as in DRI systems utilizing hydrogen as the process gas and/or hydrogen makeup gas, and the disclosed subject matter is equally applicable to such embodiments of a DRI system.

In some aspects, the depicted embodiment of the DRI system 100 may be similar to a conventional DRI plant, system, and/or process/method. For example, a pre-reducing furnace 1A and main reducing furnace 1B together may receive an iron oxide 2 and discharge a product DRI 3B. Top gas 4 from the combined main reducing furnace 1B and the pre-reducing furnace 1A (e.g., from the pre-reducing furnace 1A as described in more detail below) generally includes spent gas after the reduction of the iron oxide 2, contains the reaction product, such as H2O and CO2, as well as the unused reductant, such as H2, CO, and CH4.

After the top gas 4 is cooled and cleaned with a top gas scrubber 5 (TGS 5), most of cleaned process gas 7 is recycled to the combined main reducing furnace 1B and the pre-reducing furnace 1A through the reduction gas loop since it still contains H2 and CO. What is called the top gas fuel 6 (TGF 6), which, in some embodiments, is the excess gas caused by the volume expansion via NG reforming, may be removed from the reduction gas loop and combusted as reformer burner fuel. In some embodiments, the top gas fuel 6 may optionally be supplemented with makeup burner fuel gas 20, as required. Makeup NG 16 is added to the cleaned process gas 7 downstream of a compressor 8, and a mixed gas stream 9 may be preheated with a preheater 10 (e.g., a recuperator or the like). However, it should be appreciated that the present disclosure may be equally applicable to DRI systems and method utilizing makeup hydrogen rather than makeup NG 16 and/or a makeup gas that includes both hydrogen and NG as well as other process gas compositions.

A preheated feed gas 11 may be fed to the reformer tubes containing a catalyst in the reformer 12, which enhances the reforming reaction of the methane derived from the NG to produce H2 and CO for the reductant of the iron oxide. Optionally and as illustrated, enrichment NG 18 and/or oxygen 19 may be added to the reformed gas 13 to increase CH4 content and temperature, before feeding a resulting bustle gas 14 to the combined main reducing furnace 1B and the pre-reducing furnace 1A (e.g., via a bustle port of the main reducing furnace 1B as described in more detail below).

Optionally and as shown, a carburizing hydrocarbon gas (carburizing gas 17) may be injected into the combined main reducing furnace 1B and the pre-reducing furnace 1A, such as a transition zone thereof, such as via a carburizing gas port of the main reducing furnace 1B, in at least some embodiments. Generally, the carburizing gas 17 may be injected into the combined main reducing furnace 1B and the pre-reducing furnace 1A at a position below the position where the bustle gas 14 is injected and/or downstream of the position where the bustle gas 14 is injected with respect to the flow of the iron oxide 2 and/or DRI product(s) 3A, 3B. The carburizing gas 17 generally serves to carburize the DRI product 3A and/or 3B.

In various embodiments disclosed herein, the transition zone of the combined main reducing furnace 1B and the pre-reducing furnace 1A and/or the main reducing furnace 1B may be defined as the portion below injection of the bustle gas 14 (or downstream thereof with respect to the flow of the iron oxide 2 and/or DRI product(s) 3A, 3B) and at or above injection of the carburizing gas 17 (or at or upstream thereof with respect to the flow of the iron oxide 2 and/or DRI product(s) 3A, 3B). All bustle gas 14 injected through the main bustle ports (located in, for example, a lower section of the combined main reducing furnace 1B and the pre-reducing furnace 1A, a lower section of the main reducing furnace 1B, and/or below the reduction zone) flows upward through the iron oxide bed(s).

In the conventional systems/methods, the temperature and gas composition of the top gas 4 or gas within an upper section of a suitable SF are inherently determined by the mass and energy transfer between a bustle gas and a charged iron oxide. The reduction speed, temperature, and/or gas quality at the upper section of such a conventional SF generally cannot be independently controlled, other than by the reduction/bustle gas. For example, the initial reduction speed could be too high as the gas temperature and/or quality gets too high at the upper section in the SF when an excessive flow rate and/or temperature for the bustle gas is applied to bump up the production rate or metallization % for the product DRI.

Referring still to FIG. 1, embodiments of the DRI system 100 and associated process/methods of the present subject matter may especially differ from prior or conventional DRI system and process with respect the pre-reducing furnace 1A, the main reducing furnace 1B, and/or a reducing gas heat exchanger 21, as disclosed herein. Generally, the reduction of iron oxide from Fe2O3 to FeO may take place or substantially take place within the pre-reducing furnace 1A. For example, iron oxide or a feed material including iron oxide (referred to as iron oxide 2 herein) may be provided to an iron oxide intake positioned at or approximately at a top of the pre-reducing furnace 1A. In various embodiments, the iron oxide 2 may only contain or substantially contain (e.g., 80% or more by weight, such as 90% or more) Fe2O3 and/or Fe3O4.

A reducing gas (e.g., main top gas 22 from the main reducing furnace 1B) may be injected within the pre-reducing furnace 1A, such as via a reducing gas port thereof, and counterflowed in the pre-reducing furnace 1A with respect to a flow of the charged iron oxide 2 in order to partially reduce the iron oxide 2. Thus, a resulting partially reduced DRI product 3A only containing or substantially containing (e.g., 80% or more by weight) FeO may be discharged from a reduced iron discharge and/or a bottom of the pre-reducing furnace 1A. In some embodiments, the iron oxide 2 may be partially reduced within the pre-reducing furnace at a temperature less than 700° C.

The partially reduced DRI product 3A discharged from the reduced iron discharge of the pre-reducing furnace 1A may be subsequently provided to the main reducing furnace 1B. In some embodiments, a conduit 23 may be coupled between the reduced iron discharge of the pre-reducing furnace 1A and a main iron oxide intake of the main reducing furnace 1B. The conduit 23 may include a pipe and/or multiple concentrically arranged pipes, in at least some embodiments. Optionally and as shown, a seal gas 24 may be provided to the conduit 23, such as via a seal gas intake, port, or the like. The seal gas 24 within the conduit 23 generally diverts the main top gas 22 into the main top gas offtake of the main reducing furnace 1B while not oxidizing the partially reduced DRI product 3A discharged from the pre-reducing furnace 1A. For example, the seal gas 24 may prevent or reduce re-oxidation of the partially reduced DRI product 3A within the conduit 23. In some embodiments, the partially reduced DRI product 3A subsequently charged to the main reducing furnace 1B may only contain or substantially contain FeO via control of the oxidizing potential of the seal gas 24 to avoid re-oxidation of the partially reduced DRI product 3A.

The main reducing furnace 1B generally includes a main iron oxide intake at or approximately at a top thereof to receive the charge of the partially reduced DRI product 3A. The main reducing furnace 1B generally includes a bustle port or the like for injection of a reducing gas (bustle gas 14) into the main reducing furnace 1B. It should be appreciated that bustle gas 14, as used herein, may predominantly refer to reducing gas or reduction gas injected within the main reducing furnace 1B and counterflowed within the main reducing furnace 1B with respect to the flow of the partially reduced DRI product 3A in order to further reduce the partially reduced DRI product 3A. Reducing gas or reduction gas, as used herein, may more generally refer to any gas utilized within the pre-reducing furnace 1A and/or main reducing furnace 1B for the reduction of iron oxide. The bustle gas 14 may generally include, at least in part, process gas containing the top gas 4 and/or byproducts thereof (e.g., cleaned, compressed, heated, reformed, supplemented with other gases, otherwise processed, or the like).

After further reduction of the partially reduced DRI product 3A within the main reducing furnace 1B, a resulting DRI product 3B may be discharged at or near a bottom of the main reducing furnace 1B, such as via a reduced iron discharge. In some embodiments, the partially reduced DRI product 3A may be further reduced within the main reducing furnace 1B at a temperature greater than or equal to 700° C. The resulting DRI product 3B may only contain or substantially contain (e.g., 80% or more by weight) elemental and/or metallic iron.

The bustle gas 14 injected within the main reducing furnace 1B may flow up in the main reducing furnace 1B and be subsequently exhausted as main top gas 22 near the top of the main reducing furnace 1B, such as via a main top gas offtake located above the bustle port of the main reducing furnace 1B, after the completion of FeO reduction to metallic iron (e.g., elemental iron) within the main reducing furnace 1B. Thus, it should be appreciated that main top gas 22 results from or is the byproduct of further reduction of the partially reduced DRI product 3A within the main reducing furnace 1B.

As shown in FIG. 1, the DRI system 100 may include the reducing gas heat exchanger 21 fluidly coupled between pre-reducing furnace 1A (e.g., the reducing gas port thereof) and the main reducing furnace 1B (e.g., the main top gas offtake thereof). It should be appreciated that the flowpath defined through the reducing gas heat exchanger 21 is separate and distinct from the flowpath(s) defined through conduit 23. The reducing gas heat exchanger 21 is generally configured to cool the main top gas 22, or at least a first portion 22A thereof, prior to injection into the pre-reducing furnace 1A for use as the reducing gas. For example and as shown in FIG. 1, the main top gas 22 exhausted from the main reducing furnace 1B may be flown through the reducing gas heat exchanger 21 and cooled by TGF 6, or at least a portion 6A thereof, from the TGS 5. However, it should be appreciated that any fluid having a lower temperature than the main top gas 22 may be utilized as the working fluid of the reducing gas heat exchanger 21 and cool the main top gas 22.

In the illustrated embodiment, top gas 4 resulting from the initial/partial reduction of the iron oxide 2 within the pre-reducing furnace 1A utilizing main top gas 22 may be removed from the pre-reducing furnace 1A, such as via a top gas offtake thereof. The top gas 4 may generally be utilized in a process gas recycling system of the DRI system 100 allowing for processed top gas 4 (e.g., after cleaning, compressing, preheating, reforming, supplementation, and/or the like) to be utilized as at least a portion of bustle gas 14. In some embodiments and as shown, the TGF 6 may be a substream or portion of cleaned process gas 7 (e.g., de-dusted and quenched top gas 4). The TGS 5 described briefly above may generally be fluidly coupled with the top gas offtake of the pre-reducing furnace 1A and may optionally include a top gas fuel offtake for providing the TGF 6. However, in other configurations, cleaned process gas 7 may be split downstream of the TGS 5 to form the TGF 6 and/or the gas utilized for cooling the main top gas 22 within the reducing gas heat exchanger 21. In other words, such process gas utilized for cooling in the reducing gas heat exchanger 21 is not required to be used as burner fuel but may be in many embodiments.

The main top gas 22 may be provided to the pre-reducing furnace 1A after temperature adjustment (e.g., temperature reduction or cooling) within the reducing gas heat exchanger 21. In some embodiments, only a portion of main top gas 22A may be cooled within the reducing gas heat exchanger 21 in order to avoid reducing the temperature of the main top gas 22 too much. For example and as shown, a main top gas bypass, conduit, or the like may be fluidly coupled between the reducing gas port of the pre-reducing furnace 1A and the main top gas offtake of the main reducing furnace 1B. Such main top gas bypass general bypasses or flows another portion of main top gas 22B around the reducing gas heat exchanger 21 to provide the another portion of the main top gas 22B for injection into the pre-reducing furnace 1A. Optionally and as shown, the portions 22A, 22B of the main top gas 22 may be combined upstream of the pre-reducing furnace 1A. A valve may be provided in the main top gas bypass in order to selectively allow flow of the another portion of the main top gas 22A and/or control a ratio of the portions 22A, 22B of the main top gas 22 and thus control the degree of temperature reduction/cooling of the main top gas 22.

After the completion of the reduction from Fe2O3 to FeO in the pre-reducing furnace 1A, the resulting top gas 4 from the pre-reducing furnace 1A may be provided to the TGS 5. It should be appreciated that, in several embodiments, the top gas 4 exhausted gas to the TGS 5 should have a lower temperature than that in a conventional DR plant because of the heat transfer with the TGF 6 (or other process gas) in the reducing gas heat exchanger 21. This may advantageously result in lower water consumption in the TGS 5.

This cooling of the main top gas 22 allows for realization of the ideal heat pattern in the pre-reducing furnace 1A for the reduction of the iron oxide 2, which may be CA in at least some exemplary embodiments. In some embodiments, only a portion of the TGF 6A may be flown through the reducing gas heat exchanger 21 to reduce the temperature of the main top gas 22 and/or to increase the temperature of the TGF 6 in order to avoid reducing the temperature of the main top gas 22 too much. For example and as shown, a TGS bypass, conduit, or the like may include an inlet fluidly coupled between the top gas fuel offtake of the TGF 5 and the reducing gas heat exchanger 21 in order to bypass or flow another portion of TGS 6B around the reducing gas heat exchanger 22 to provide the another portion of the TGS 6B for use as a component of a burner fuel for the reformer 12. Optionally and as shown, the portions 6A, 6B of the TGF 6 may be combined downstream of the reducing gas heat exchanger 21. A valve may be provided in the TGS bypass in order to selectively allow flow of the another portion of the TGF 6B and/or control a ratio of the portions 6A, 6B of the TGF 6 and thus control the degree of temperature reduction/cooling of the main top gas 22 and/or temperature increase of the TGS 6.

As described above, the TGF 6 may be used as the burner fuel of the reformer 12 in addition to utilization to cool and/or adjust the temperature of the main top gas 22 within the reducing gas heat exchanger 21 prior to use as the reducing as in the pre-heating furnace 1A. The TGF 6 may gain additional heat from the main top gas 22 exhausted from the main reducing furnace 1B, which results in reducing an amount of or even eliminating the need for additional NG consumption as the burner fuel of reformer 12. Thus, the amount of makeup burner fuel gas 20 may be reduced or, in some embodiments, may be removed as unnecessary or redundant.

Generally and as shown, ambient air, combustion air, or the like (combustion air 25) may be provided to the burner(s) of the reformer 12. Thus, the combination of the combustion air 25 and the reformer burner fuel gas (including, e.g., TGS 6 after being heated within the reducing gas heat exchanger 21, at least in part 6A, and optionally supplemented with burner fuel gas 20) may be combusted in order to drive the reformer reaction within the reformer 12. Optionally and as shown, the preheater 10 may be fluidly coupled between a supply of the combustion air 25 and the burner(s) of the reformer 12 in order to preheat the combustion air 25. Optionally, exhaust gas or flue gas resulting from combustion of the reformer burner fuel gas (which also may be formed at least in part from TGF 6) may be provided to the preheater 10 to transfer heat to the mixed gas stream 9 and/or the combustion air 25. In some embodiments, the combusted TGF 6 and/or combusted reformer fuel gas may be exhausted from the DRI system 100 after utilization within the preheater 10 via an ejector stack (stack 80).

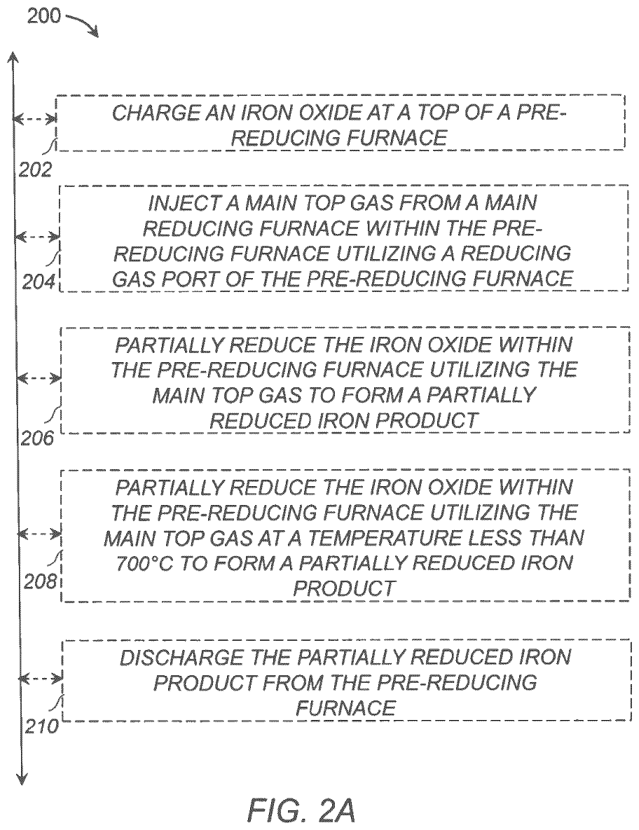

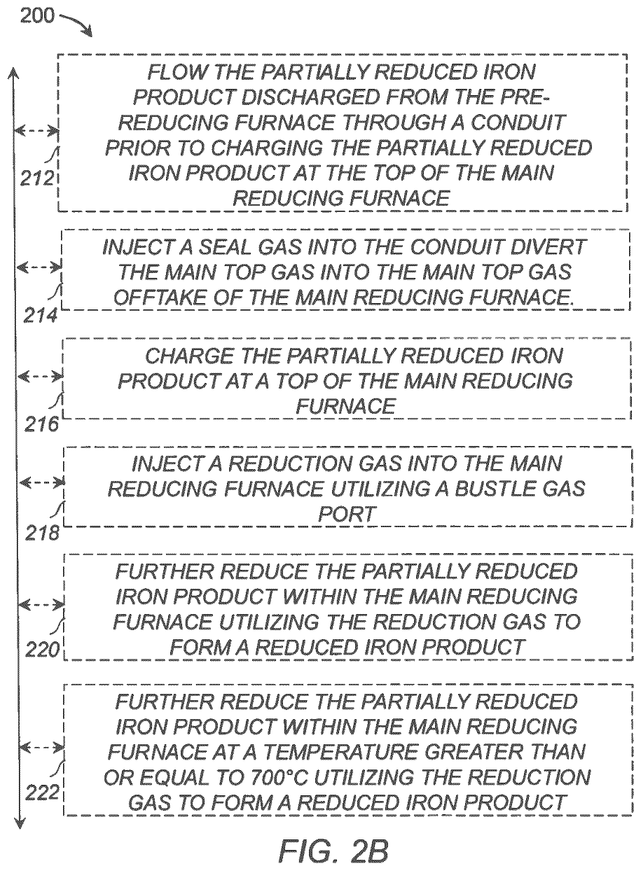

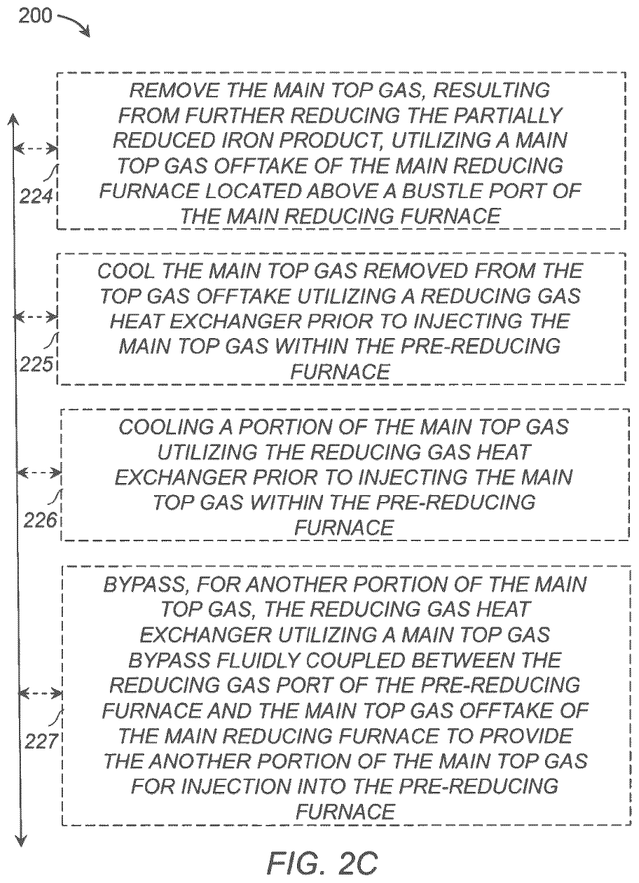

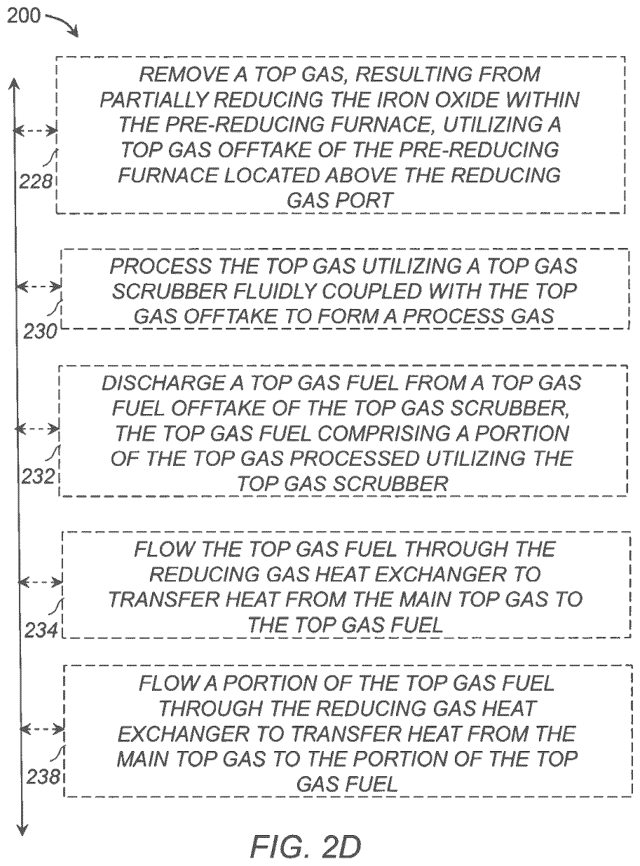

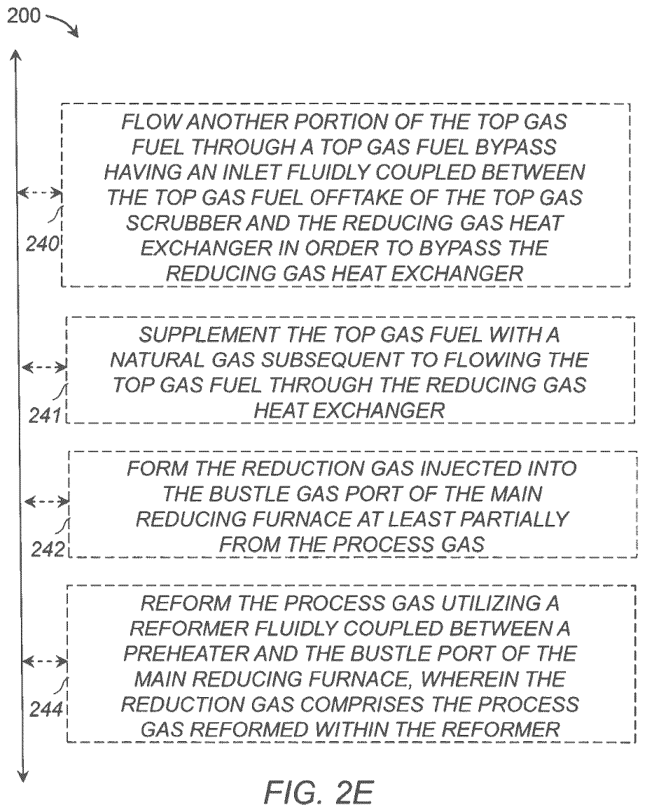

Referring now to FIGS. 2A-2E, FIGS. 2A-2E illustrate exemplary embodiments of method elements, one or more of which may be implemented in a method for the direct reduction of iron utilizing a pre-reducing furnace, a main reducing furnace, and/or a reducing gas heat exchanger, in accordance with aspects of the present subject matter. Any of such method 200 elements may, optionally, be computer-implemented, such as via a suitable control unit. Furthermore, the method 200 and/or elements thereof may be utilized to control or in association with any of the embodiments of the DRI system 100 or components thereof described herein or any other suitably configured DRI process, system, plant, SF, or the like. While FIG. 1 and some elements of method 200 are illustrated and described herein with respect to a process utilizing natural gas (NG) as added process gas, it should be appreciated that the present subject matter may be equally applicable to DRI systems and methods utilizing hydrogen, a mix of hydrogen and NG, other suitable process gases, and/or suitable components.

Referring now predominantly to FIG. 2A, the method 200 may include charging an iron oxide at a top of a pre-reducing furnace (method element 202). For example and in some embodiments, the iron oxide may include 80% or more (e.g., 80% by weight) Fe3O4, Fe2O3, or a combination of the two. In some embodiments, method 200 includes injecting a main top gas from a main reducing furnace within the pre-reducing furnace utilizing a reducing gas port of the pre-reducing furnace (method element 204). In some such embodiments or different embodiments, the method 200 may include partially reducing the iron oxide within the pre-reducing furnace utilizing the main top gas to form a partially reduced iron product (method element 206). Optionally and for example, method 200 may include partially reducing the iron oxide within the pre-reducing furnace utilizing the main top gas at a temperature less than 700° C. to form a partially reduced iron product (method element 208). In some embodiments, the partially reduced iron product may include 80% or more FeO. Furthermore or alternatively, the method 200 may include discharging the partially reduced iron product from the pre-reducing furnace (method element 210).

Referring now predominantly to FIG. 2B, the method 200 may include flowing the partially reduced iron product discharged from the pre-reducing furnace through a conduit prior to charging the partially reduced iron product at the top of the main reducing furnace (method element 212). In some such embodiments, the method 200 may also include injecting a seal gas into the conduit to divert the main top gas into the main top gas offtake of the main reducing furnace (method element 214). Additionally or alternatively, the injecting the seal gas within the conduit may prevent or reduce re-oxidation of the partially reduced DRI product 3A within the conduit 23.

In further or different embodiments, the method 200 may include charging the partially reduced iron product at a top of the main reducing furnace (method element 216). In some embodiments, the method 200 may include injecting a reduction gas into the main reducing furnace utilizing a bustle gas port (method element 218). Method 200 may include further reducing the partially reduced iron product within the main reducing furnace utilizing the reduction gas to form a reduced iron product (method element 220). For example, the method 200 may include further reducing the partially reduced iron product within the main reducing furnace at a temperature greater than or equal to 700° C. utilizing the reduction gas to form a reduced iron product (method element 222). In various embodiments, the reduced iron product may include 80% or more (e.g., 80% or more by weight) metallic iron, elemental iron, and/or cementite (Fe3C).

Referring now predominantly to FIG. 2C and additionally or alternatively, the method 200 may include removing the main top gas, resulting from further reducing the partially reduced iron product, utilizing a main top gas offtake of the main reducing furnace located above a bustle port of the main reducing furnace (method element 224). In some embodiments, the method 200 may include cooling the main top gas removed from the top gas offtake utilizing a reducing gas heat exchanger prior to injecting the main top gas within the pre-reducing furnace (method element 225). Additionally or alternatively, the method 200 may include cooling a portion of the main top gas utilizing the reducing gas heat exchanger prior to injecting the main top gas within the pre-reducing furnace (method element 226). Additionally or alternatively, the method 200 may include bypassing, for another portion of the main top gas, the reducing gas heat exchanger utilizing a main top gas bypass fluidly coupled between the reducing gas port of the pre-reducing furnace and the main top gas offtake of the main reducing furnace to provide the another portion of the main top gas for injection into the pre-reducing furnace (method element 227).

Referring now predominantly to FIG. 2D, the method 200 may additionally or alternatively include removing a top gas, resulting from partially reducing the iron oxide within the pre-reducing furnace, utilizing a top gas offtake of the pre-reducing furnace located above the reducing gas port (method element 228). In method element 230, the method 200 may include processing the top gas utilizing a top gas scrubber fluidly coupled with the top gas offtake to form a process gas. Some embodiments of the method 200 may include discharging a top gas fuel from a top gas fuel offtake of the top gas scrubber, the top gas fuel comprising a portion of the top gas processed utilizing the top gas scrubber (method element 232). In an additional or alternative method element 234, the method 200 may include flowing the top gas fuel through the reducing gas heat exchanger to transfer heat from the main top gas to the top gas fuel. Furthermore or alternatively, the method 200 may include flowing a portion of the top gas fuel through the reducing gas heat exchanger to transfer heat from the main top gas to the portion of the top gas fuel (method element 238). Referring now briefly also to FIG. 2E, additionally or alternatively, the method 200 may include flowing another portion of the top gas fuel through a top gas fuel bypass having an inlet fluidly coupled between the top gas fuel offtake of the top gas scrubber and the reducing gas heat exchanger in order to bypass the reducing gas heat exchanger (method element 240). The top gas fuel, the portion of the top gas fuel, and/or the combined portions of the top gas fuel may be utilized as burner fuel for a reformer downstream of the reducing gas heat exchanger.

Referring now to FIG. 2E, additionally or alternatively, the method 200 may include supplementing the top gas fuel with a natural gas subsequent to flowing the top gas fuel through the reducing gas heat exchanger (method element 241), e.g., prior to utilization as reformer burner fuel gas. Additionally or alternatively, the method 200 may include forming the reduction gas injected into the bustle gas port of the main reducing furnace at least partially from the process gas (method element 242). In some such embodiments or different embodiments, the method 200 may include reforming the process gas utilizing a reformer fluidly coupled between a preheater and the bustle port of the main reducing furnace, wherein the reduction gas comprises the process gas reformed within the reformer (method element 244).

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

Again, to avoid clustering issues due to the use of CA as feedstock, the Fe3O4 reduction to FeO should be completed at a temperature lower than 700° C. This is based on experimental results. In a conventional plant, the Fe3O4 reduction occurs between 700° C. and 760° C. Thus, one needs to decrease the process temperature where Fe3O4 is reduced to FeO. There are two possible operational efforts to realize this heat pattern, lowering the reducing gas flow rate or lowering the temperature of the reducing gas before injection into the reducing furnace. However, both can lower the product quality due to the shortage of heat and/or reductants.

Embodiments of the pre-reducing furnace and reducing gas heat exchanger of the present disclosure enable control of the process conditions for the Fe3O4 reduction separately from any other process conditions. Thus, the poor product quality resulting from lowering the reducing gas flow rate or lowering the temperature of the reducing gas before injection into the reducing furnace does not occur.

Embodiments of the present disclosure utilize the pre-reducing furnace and the reducing gas heat exchanger located between and/or fluidly coupled between the pre-reducing furnace and the main reducing furnace in order to independently control the reducing gas temperature and the initial temperature of reduction. In several embodiments, a DRI system including the disclosed pre-reducing furnace, the main reducing furnace, and the reducing gas heat exchanger between them enables cooling of exhausted gas from the main reducing furnace in order to realize the ideal heat pattern in the pre-reducing furnace without any changes in the reduction conditions in the main reducing furnace. In some embodiments, only a portion of the main top gas may be cooled utilizing the reducing gas heat exchanger, and another portion of the main top gas may bypass the reducing gas heat exchanger utilizing a main top gas bypass fluidly coupled between the pre-reducing furnace and main reducing furnace. By selectively allowing the flow of the portion of the main top gas through the main top gas bypass and/or altering an amount of the portion flown through the main top gas bypass, the degree of cooling of the main top gas may be independently controlled.

Top gas fuel may be the cooling fluid flown through the reducing gas heat exchanger. In which case, the reducing gas heat exchanger may also function to preheat the top gas fuel, which results in reducing an amount of or even eliminating the need for additional NG consumption as the burner fuel of the reformer. In some embodiments, only a portion of the top gas fuel may flow through the reducing gas heat exchanger, and another portion of the top gas fuel may bypass the reducing gas heat exchanger utilizing a top gas fuel bypass having an inlet fluidly coupled between top gas scrubber and the reducing gas heat exchanger. By selectively allowing the flow of the portion of the top gas fuel through the top gas fuel bypass and/or altering an amount of the portion flown through the top gas fuel bypass, the degree of cooling of the main top gas and/or heating of the top gas fuel may be independently controlled. Alternatively, other process gas in a suitable DRI system may be utilized as the cooling fluid flown through the reducing gas heat exchanger, e.g., as used in a hydrogen DRI system/process.

Although the present disclosure is illustrated and described with reference to embodiments and examples thereof, it will be readily apparent to those of ordinary skill in the art that other embodiments and examples may perform similar functions and/or achieve like results. All such equivalent embodiments and examples are within the scope of the present disclosure, are contemplated thereby, and are intended to be covered by the following, non-limiting Claims for all purposes.

What is claimed is:

1. A system for the direct reduction of iron, the system comprising:
a pre-reducing furnace comprising:
an iron oxide intake located at a top of the pre-reducing furnace and configured to receive an iron oxide,
a reducing gas port configured to inject a main top gas from a main reduction furnace into the pre-reducing furnace for partial reduction of the iron oxide received via the iron oxide intake, and
a reduced iron discharge at a bottom of the pre-reducing furnace and configured to discharge a partially reduced iron product;
the main reducing furnace comprising:
a main iron oxide intake located at top of the main reducing furnace and configured to receive the partially reduced iron product, and
a main top gas offtake located above a bustle port and configured to remove the main top gas resulting from reduction of the partially reduced iron product within the main reducing furnace; and
a reducing gas heat exchanger fluidly coupled between the reducing gas port of the pre-reducing furnace and the main top gas offtake of the main reducing furnace, the reducing gas heat exchanger configured to cool the main top gas prior to injection into the pre-reducing furnace.

2. The system of claim 1, wherein the pre-reducing furnace is configured to partially reduce the iron oxide at a temperature less than 700°C., and the main reducing furnace is configured to reduce the partially reduced iron at a temperature greater than or equal to 700°C.

3. The system of claim 1, wherein cooling the main top gas prior to injection into the pre-reducing furnace includes cooling a portion of the main top gas, and wherein the system further comprises:
a main top gas bypass fluidly coupled between the reducing gas port of the pre-reducing furnace and the main top gas offtake of the main reducing furnace and bypassing the reducing gas heat exchanger to provide another portion of the main top gas for injection into the pre-reducing furnace.

4. The system of claim 1, wherein the pre-reducing furnace further comprises a top gas offtake located above the reducing gas port and configured to remove top gas resulting from partial reduction of iron oxide within the pre-reducing furnace, the system further comprising:
a top gas scrubber fluidly coupled with the top gas offtake and configured to process the top gas to form a process gas, the top gas scrubber comprising a top gas fuel offtake configured for providing a portion of the processed top gas as a top gas fuel.

5. The system of claim 4, wherein the reducing gas heat exchanger is fluidly coupled to the top gas fuel offtake of the top gas scrubber and configured to transfer heat from the main top gas to the top gas fuel.

6. The system of claim 5, wherein transferring heat from the main top gas to the top gas fuel includes transferring heat from the main top gas to a portion of the top gas fuel, and wherein the system further comprises:
a top gas fuel bypass having an inlet fluidly coupled between the top gas fuel offtake of the top gas scrubber and the reducing gas heat exchanger and bypassing the reducing gas heat exchanger.

7. The system of claim 4, wherein the main reducing furnace further comprises the bustle port configured to inject a reduction gas into the main reducing furnace, the reduction gas formed from the process gas.

8. The system of claim 7, further comprising:
a reformer fluidly coupled between a preheater and the bustle port of the main reducing furnace, wherein the reduction gas comprises the process gas reformed within the reformer.

9. The system of claim 8, wherein the reformer is configured to utilize the top gas fuel, subsequent to heat transfer with the main top gas in the reducing gas heat exchanger, supplemented with a natural gas as burner fuel for the reformer.

10. The system of claim 1, further comprising:
a conduit coupled between the reduced iron discharge of the pre-reducing furnace and the main iron oxide intake of the main reducing furnace and configured to provide the partially reduced iron product from the pre-reducing furnace to the main reducing furnace, the conduit comprising a seal gas intake configured to divert the main top gas into the main top gas offtake of the main reducing furnace.

11. A method for the direct reduction of iron, the method comprising:
charging an iron oxide at a top of a pre-reducing furnace;
injecting a main top gas from a main reducing furnace within the pre-reducing furnace utilizing a reducing gas port of the pre-reducing furnace;
partially reducing the iron oxide within the pre-reducing furnace utilizing the main top gas to form a partially reduced iron product;
discharging the partially reduced iron product from the pre-reducing furnace;
charging the partially reduced iron product at a top of the main reducing furnace;
injecting a reduction gas into the main reducing furnace utilizing a bustle gas port;
further reducing the partially reduced iron product within the main reducing furnace utilizing the reduction gas to form a reduced iron product;
removing the main top gas, resulting from further reducing the partially reduced iron product, utilizing a main top gas offtake of the main reducing furnace located above a bustle port of the main reducing furnace; and
cooling the main top gas removed from the top gas offtake utilizing a reducing gas heat exchanger prior to injecting the main top gas within the pre-reducing furnace.

12. The method of claim 11, wherein the iron oxide comprises 80% or more at least one of Fe3O4 or Fe2O3, the partially reduced iron product comprises at least 80% FeO, and the reduced iron product comprises at least 80% at least one of elemental iron, metallic iron, or cementite.

13. The method of claim 11, wherein partially reducing the iron oxide within the pre-reducing furnace comprises partially reducing the iron oxide at a temperature less than 700°C., and further reducing the partially reduced iron product within the main reducing furnace comprises further reducing the partially reduced iron at a temperature greater than or equal to 700°C.

14. The method of claim 11, wherein cooling the main top gas prior to injection into the pre-reducing furnace includes cooling a portion of the main top gas utilizing the reducing gas heat exchanger prior to injecting the main top gas within the pre-reducing furnace, wherein the method further comprises:
bypassing, for another portion of the main top gas, the reducing gas heat exchanger utilizing a main top gas bypass fluidly coupled between the reducing gas port of the pre-reducing furnace and the main top gas offtake of the main reducing furnace to provide the another portion of the main top gas for injection into the pre-reducing furnace.

15. The method of claim 11, further comprising:
removing a top gas, resulting from partially reducing the iron oxide within the pre-reducing furnace, utilizing a top gas offtake of the pre-reducing furnace located above the reducing gas port;
processing the top gas utilizing a top gas scrubber fluidly coupled with the top gas offtake to form a process gas; and
discharging a top gas fuel from a top gas fuel offtake of the top gas scrubber, the top gas fuel comprising a portion of the top gas processed utilizing the top gas scrubber.

16. The method of claim 15, further comprising:
flowing the top gas fuel through the reducing gas heat exchanger to transfer heat from the main top gas to the top gas fuel.

17. The method of claim 16, wherein flowing the top gas fuel through the reducing gas heat exchanger to transfer heat from the main top gas to the top gas fuel comprises flowing a portion of the top gas fuel through the reducing gas heat exchanger to transfer heat from the main top gas to the portion of the top gas fuel, the method further comprising:
flowing another portion of the top gas fuel through a top gas fuel bypass having an inlet fluidly coupled between the top gas fuel offtake of the top gas scrubber and the reducing gas heat exchanger in order to bypass the reducing gas heat exchanger.

18. The method of claim 15, further comprising:
forming the reduction gas injected into the bustle gas port of the main reducing furnace from the process gas.

19. The method of claim 18, further comprising:
reforming the process gas utilizing a reformer fluidly coupled between a preheater and the bustle port of the main reducing furnace, wherein the reduction gas comprises the process gas reformed within the reformer.

20. The method of claim 11, further comprising:
flowing the partially reduced iron product discharged from the pre-reducing furnace through a conduit prior to charging the partially reduced iron product at the top of the main reducing furnace; and
injecting a seal gas into the conduit to divert the main top gas into the main top gas offtake of the main reducing furnace.
